(19) United States
(12) Patent Application Publication
(10) Pub. No.: US 2020/0188964 A1
(43) Pub. Date: Jun. 18, 2020

(54) traffic road fence cleaning equipment

(71) Applicant: Lijun Liang, Dongguan City (CN)

(72) Inventor: Lijun Liang, Dongguan City (CN)

(21) Appl. No.: 16/796,929

(22) Filed: Feb. 20, 2020

(30) Foreign Application Priority Data
Nov. 26, 2019 (CN) 2019111761687

(51) Int. Cl. B08B 3/02; B08B 1/00; B08B 1/04; E01H 1/00

(52) U.S. Cl. CPC B08B 3/02; E01H 1/005; B08B 1/04; B08B 1/001

(57) ABSTRACT

The invention discloses a traffic road fence cleaning device, comprising a U-shaped main body support frame, the U-shaped main body support frame is composed of a first main body beam, a first main body beam, and a second main body beam, and the first body A first cleaning column and a second cleaning column are provided on the lower side of the side member, a first power system is provided on the upper side of the U-shaped main body, support frame, and a second power system is provided on the upper side of the third body side member. The front side of the U-shaped main body support frame is provided with a drum cleaning system, and a water supply system is provided above the third main body longitudinal beam. The dirt on the surface comes off. The suction pipe collects and treats part of the water mist and dust to prevent secondary pollution. The cleaning roller is responsible for the final wiping and secondary cleaning functions to ensure the cleaning quality of the traffic fence. Efficient and fast cleaning of traffic fences.

### CROSS-REFERENCES TO RELATED APPLICATIONS

The present application claims priority from Chinese application No. 2019111761687 filed on Nov. 26, 2019 which is hereby incorporated by reference in its entirety.

### TECHNICAL FIELD

The present invention relates to the technical field of traffic road fence cleaning equipment, in particular to a traffic road fence cleaning equipment.

### BACKGROUND OF THE INVENTION

In the field of traffic fence cleaning equipment, as an important part of traffic management work, the road is a comprehensive reflection of the city's economy, culture, city appearance and other aspects. It marks the level of a city's management level. With the improvement of people's economic level, the number of cars is increasing. In busy traffic, traffic fences play an important role. Due to natural factors such as vehicle exhaust emissions, rain and dust, traffic fences will foul over time, The guardrail sign loses its warning effect, and also loses its beauty, which affects the appearance of the road. Manual cleaning not only has a huge workload and low efficiency, but also poses a certain threat to the safety of workers.

### BRIEF SUMMARY OF THE INVENTION

The purpose of the present invention is to provide a cleaning device for traffic road fences. In response to the phenomenon of easy fouling of traffic fences, a cleaning device for traffic road fences is designed to enable efficient and rapid cleaning of traffic fences.

A traffic road fence cleaning device of the present invention includes a U-shaped main body support frame, the U-shaped main body support frame is composed of a first main body beam, a first main body beam, and a second main body beam, and the first main body beam The first main body longitudinal beam is fixed at the rear end of the first main body beam near the left side, the first main body longitudinal beam is rearwardly installed, and the second main body longitudinal beam is fixed at the left side. The rear end of the first main body beam is close to the right side, the second main body beam is extended rearwardly, and the third main body beam extended rearwardly is fixed in the middle of the rear end of the first main body beam. The rear end of the third main body beam is fixed with a second main body beam that extends left and right. The second main body beam extends to the left and is fixedly connected to the rear end of the first main body beam. The second main body beam extends to the right to the rear end of the stringer of the second body is fixedly connected.

A first cleaning column and a second cleaning column are provided on a lower side of the first main body longitudinal beam, the first cleaning column is located at a rear side of the second cleaning column, and the first cleaning column is about the U-shaped body Two support frames are provided symmetrically, and the second cleaning column is provided symmetrically with respect to the U-shaped main body support frame. A first power system is provided on the upper side of the U-shaped main body support frame. A second power system is provided on the upper side of the beam, a drum cleaning system is provided on the front side of the U-shaped main body support frame, and a water supply system is provided above the third main body longitudinal beam.

On the basis of the above technical solution, the first cleaning column is provided with a first water inlet through hole which opens upward, and a first rotating mating body extending upward is fixed at the top of the first cleaning column, and the first body The longitudinal beam is provided with a first cleaning column rotation fitting hole and a second cleaning column rotation fitting hole which penetrate vertically. The first cleaning column rotation fitting hole is located at a rear side of the second cleaning column rotation fitting hole. A rotation mating body is rotationally mated in the rotation mating hole of the first cleaning column, a second water inlet through hole is provided in the first rotation mating body, and a first is fixed at the top of the first rotation mating body. Rotating support block, the first rotating support block is provided with a third water inlet through hole which penetrates up and down, the first water inlet through hole, the second water inlet through hole and the third water inlet through hole Connected to each other, the second cleaning column is provided with a fourth water inlet through which is opened upward. The top of the second cleaning column is fixedly provided with a second rotating mating body extending upward, and the second rotating mating body is rotated. Fit in the second cleaning stand In the rotation fitting hole, a fifth water inlet hole penetrating up and down is provided in the second rotation fitting body. A second rotation support block is fixed on the top of the second rotation coordination body. There is a sixth water inlet through hole penetrating up and down, the fourth water inlet through hole, the fifth water inlet through hole and the sixth water inlet through hole communicate with each other, and the top of the first rotation support block is fixed at the top. There is a first water inlet, a second water inlet is fixed on the top of the second rotation support block, and a first rotation projection is fixed on a side of the top of the first rotation support block near the third main body longitudinal beam. Block, a second rotary projection is fixed on a side of the top of the second rotary support block near the third main body longitudinal beam, and front and rear sides of the first rotary support block and the second rotary support block are provided with front and rear An extended first rocker, wherein the first rocker is provided with first and second rotary projection mating holes penetrating up and down, and the first rotary bump is rotationally mated with the first rotation The second rotation projection is rotationally fitted in the second rotation projection assembly in the projection fitting hole. Inside the hole, a first cleaning nozzle is fixed on a side of the first cleaning column and the second cleaning column near the third main body longitudinal beam, and the first cleaning nozzle is in an up-down direction of the first cleaning column. There are five arrays, and there are also five arrays of the first cleaning nozzles in the up and down direction of the second cleaning column. The first cleaning nozzles on the first cleaning column are provided with first and second water jets passing through the left and right. Hole, the first water spray hole on the first cleaning column communicates with the first water inlet through hole, and the first water spray hole on the second cleaning column and the fourth water inlet The water through holes communicate with each other.

On the basis of the above technical solution, the second power system includes a motor, a first rotating block is fixed on the output shaft of the motor, and a first rotating sliding projection is fixed on the rear edge of the first rotating block. A first sliding constraint projection and a second sliding constraint projection are symmetrically fixed at the top of the second main body beam left and right, and a first sliding constraint hole penetrating from left to right is provided in the first sliding constraint projection; The two sliding restraint projections are provided with a second sliding restraint hole penetrating left and right, and the first sliding restraint hole and the second sliding restraint hole are slidably provided with a first slide lever, and the front end of the first slide lever A rotary sliding projection mating body is fixedly arranged in the middle, a rotary sliding projection mating groove extending up and down is provided at the front end of the rotary sliding projection mating body, and a first A sliding fit groove, the first sliding fit groove is arranged along the front left and right rear, and the rear end of the first rocker is fixed with a first rocker projection which extends downward, and the first rocker projection Sliding fit in the first sliding fit groove.

Based on the above technical solution, the first power system includes a main motor, a main motor support body is fixed at the top of the first main body beam, and the main motor is fixedly connected to the top of the main motor support body at the top. A first gear is fixed on the output shaft of the main motor, and a second gear is meshed with the upper side of the first gear. A first transmission shaft extends left and right in the second gear, and the left end of the first transmission shaft is fixed. A first bevel gear is provided, a first rotating support body and a second rotating support body are symmetrically arranged on the left and right sides of the top end of the first main body beam, and a first rotating support ring is provided on the outer ring of the first rotating support body. A first power box support base is fixed on the top of the first rotation support body, and a first support rotation matching cavity with an upward opening is provided in the first power box support base. There is a first power box lower case extending upward. The first power box lower case is provided with a first power box lower accommodating cavity penetrating upward and downward, and the outer side of the first power box lower case is located near the top end. Have the first A power box rotation restricting ring is provided to extend upward, a first power box upper case is provided on an upper side of the first power box lower case, and the first power box upper case is rotated Fitted in the rotation restriction ring of the first power box, the first power box upper housing is provided with a first power box upper accommodating cavity facing downward, and the first power box upper housing is close to the main motor. A first power shaft mating hole extending through the receiving cavity of the first power box is provided on one side, and a side of the lower case of the first power box away from the second main body beam is provided to the first power box. A second power shaft mating hole extending through the receiving cavity under the power box is provided on the top wall of the first power box, and a first gear shaft mating hole with an opening downward is provided on the top wall of the first power box. There is a second gear shaft fitting hole with an upward opening, a first gear shaft extending up and down is provided between the first gear shaft fitting hole and the second gear shaft fitting hole, and the lower end of the first gear shaft is rotationally fitted in the second gear shaft fitting hole, the first tooth The upper end of the shaft is rotationally fitted in the first gear shaft fitting hole. A second bevel gear and a third bevel gear are fixed on the first gear shaft, and the second bevel gear is located on the upper side of the third bevel gear. The second bevel gear is meshed with the first bevel gear, the third bevel gear is meshed with a fourth bevel gear, and a second transmission shaft is rotationally fitted in the second power shaft fitting hole, The second transmission shaft extends forward and backward. Based on the above technical solution, the drum cleaning system includes a first washing drum and a second washing drum, and a side of the first rotating support ring remote from the second main body beam is fixed with a first washing drum support extending forward. A first cleaning roller support body is fixed at the front end of the first cleaning roller support rod, a first transmission box is fixed at the upper end of the first cleaning roller support body, and an opening in the first transmission box is provided downward A first gearbox accommodating cavity, the third gearbox accommodating hole extending through the first gearbox accommodating cavity is provided on a side of the first gearbox accommodating cavity near the lower case of the first power box, The first washing drum supporting body is provided with a first washing drum rotation fitting hole penetrating up and down, and the first washing drum rotation fitting hole is pivotally fitted with a first washing drum connection shaft extending up and down, and the first washing A drum is fixedly connected to the lower end of the first cleaning drum connection shaft, a first cleaning drum support block is fixed at the top end of the first cleaning drum connection shaft, and a first cleaning drum support block is fixed at the top end. A bevel gear connection shaft, a fifth bevel gear is fixed at the top end of the first bevel gear connection shaft, the front part of the second transmission shaft is rotationally fitted in the third gear shaft fitting hole, and the front end of the second transmission shaft A sixth bevel gear is fixed, and the sixth bevel gear is meshed with the fifth bevel gear.

Based on the above technical solution, the front end of the first main body beam is fixedly provided with auxiliary beams extending left and right, and the upper end of the auxiliary beam is provided with a first fixing block near the left side, and the first fixing block is located in the first A left side of a cleaning roller supporting rod, a first rotating support short shaft is fixed at the top of the first fixing block, and a first rotating supporting short shaft mating ring is provided on the outer ring of the first rotating support short shaft, and the first A first spring cylinder body is fixed on a side of the rotation support short shaft matching ring near the first cleaning drum support rod, and a first spring cavity with a rightward opening is provided in the first spring cylinder body. A first spring push rod is slidingly fitted in the spring cavity, and a first spring is press-fitted between the left end of the first spring push rod and the left side wall of the first spring cavity. The first cleaning roller support rod A second rotation support short shaft is fixed on the top, a second rotation support short shaft mating ring is provided on the outer ring of the second rotation support short shaft, and a right end of the first spring push rod is matched with the second rotation support short shaft. The ring is fixedly connected.

On the basis of the above technical solution, a left end of the first main body beam is fixedly provided with a first dust suction pipe connection block, and a left end of the first dust suction pipe connection block is fixedly provided with a left first section of dust suction pipe extending downward, A left suction pipe interface is fixed at the top of the first left section of the suction pipe, and a second left section is provided below the first cleaning column and the second cleaning column near the third main body longitudinal beam. The dust suction pipe is extended forward and backward, and the left second suction pipe is provided with a left third suction pipe extending to the left near the front end. The right end of the three-stage vacuum cleaner pipe is in communication with the front end of the second left-stage vacuum cleaner pipe, and the left end of the third pipe vacuum cleaner is in communication with the lower end of the first first-stage vacuum cleaner pipe. The second section of the suction pipe is provided with a first suction groove extending forward and backward on the right side.

Based on the above technical solution, the water supply system includes a first section of water supply pipe, the first section of water supply pipe is located above the third main body longitudinal beam, the first section of water supply pipe extends forward and backward, and the first The rear end of the section water supply pipe is connected to a second section of water supply pipe extending left and right, the left end of the second section of water supply pipe is connected to the first water inlet interface, and the front end of the first section of water supply pipe is connected to the left and right extension pipe. The third section of the water supply pipe, the left end of the third section of the water supply pipe is arranged in communication with the second water inlet.

On the basis of the above technical solution, the right end of the second main body beam is fixed with a vehicle-mounted frame connecting rod that extends to the right, the right end of the vehicle-mounted frame connecting rod is fixed with a first vehicle-mounted frame vertical rod that extends up and down, and the auxiliary beam The right end is fixedly provided with a second vehicle frame vertical rod extending up and down, and a vehicle frame connecting longitudinal beam extending forward and backward is provided between the first vehicle frame vertical rod and the second vehicle frame vertical rod, and the vehicle frame connecting vertical The front end and the rear end of the beam are fixedly connected to the rear side of the second vehicle frame vertical rod and the front side of the first vehicle frame vertical rod, respectively. A right side of the second vehicle frame vertical rod is provided with a first vehicle hook and a first Two vehicle-mounted hooks, the second vehicle-mounted hook is located above the first vehicle-mounted hook, a third vehicle-mounted hook and a fourth vehicle-mounted hook are provided on the right side of the first vehicle-mounted frame vertical bar, and the fourth vehicle-mounted hook is located at The third vehicle hook is described above.

The beneficial effects of the present invention are: the structure of the present invention is simple, and the operation is convenient. The high-pressure water flow sprayed from several cleaning nozzles on the four groups of cleaning columns, the high-pressure water flow scours the traffic fence and causes the dirt on the surface to fall off. The dust pipe collects and processes part of the water mist and dust to prevent secondary pollution. The cleaning roller is responsible for the final wiping and secondary cleaning functions, to ensure the cleaning quality of the traffic fence, and to efficiently and quickly clean the traffic fence.

### BRIEF DESCRIPTION OF THE DRAWINGS

In order to more clearly explain the embodiments of the present invention or the technical solutions in the prior art, the drawings used in the embodiments are briefly introduced below. Obviously, the drawings in the following description are just some of the present invention For those of ordinary skill in the art, other embodiments may be obtained based on these drawings without paying creative labor.

FIG. 1 is a front view of a traffic road fence cleaning device according to the present invention;

FIG. 2 is a left side view of FIG. 1 in the present invention;

FIG. 3 is a top view of FIG. 1 in the present invention;

FIG. 4 is a right side view of FIG. 1 in the present invention;

FIG. 5 is a partial view A of FIG. 1 in the present invention;

FIG. 6 is a partial view B of FIG. 4 in the present invention;

FIG. 7 is a partial view C of FIG. 2 in the present invention.

### DETAILED DESCRIPTION OF THE INVENTION

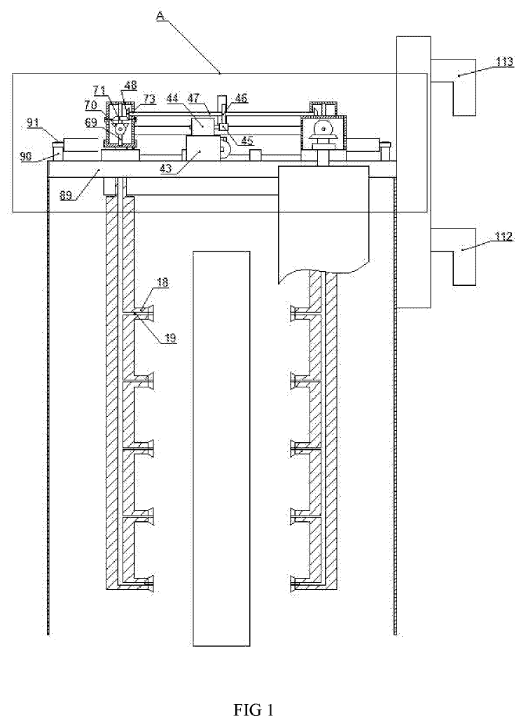

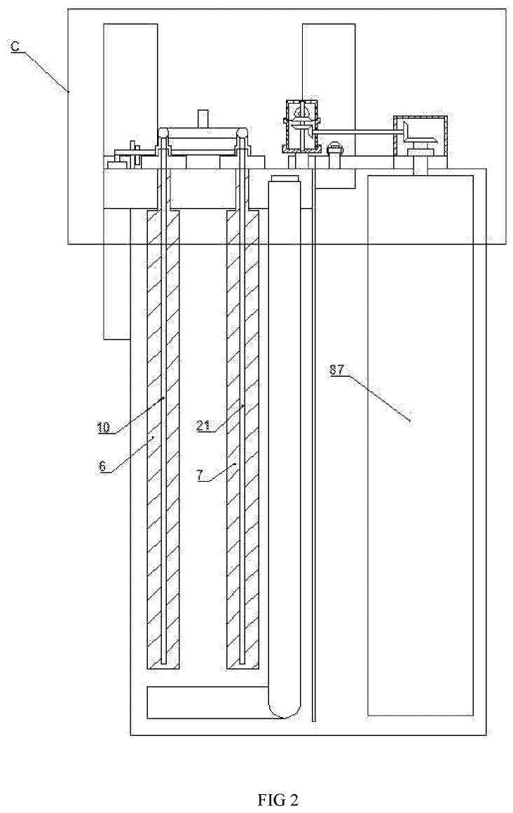

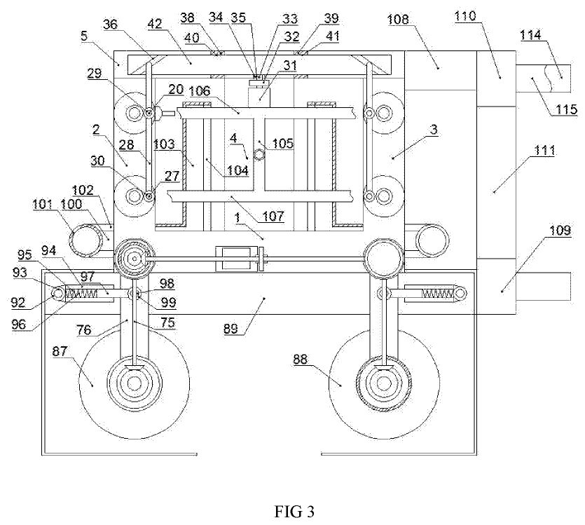

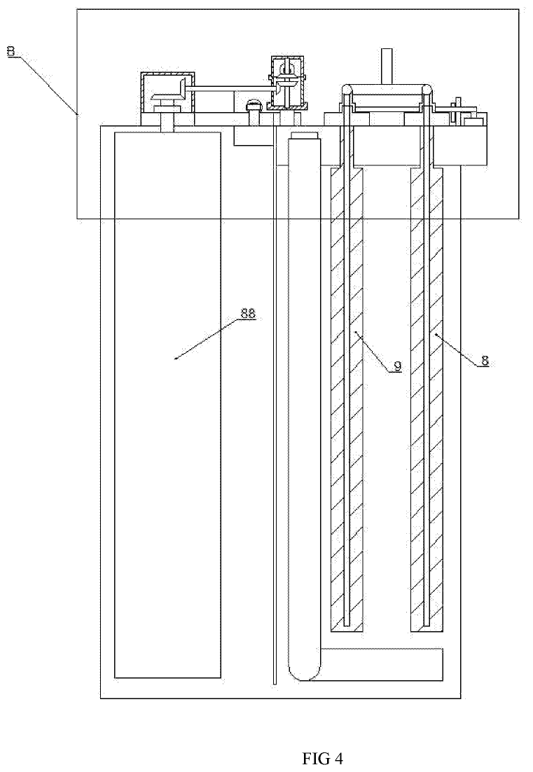

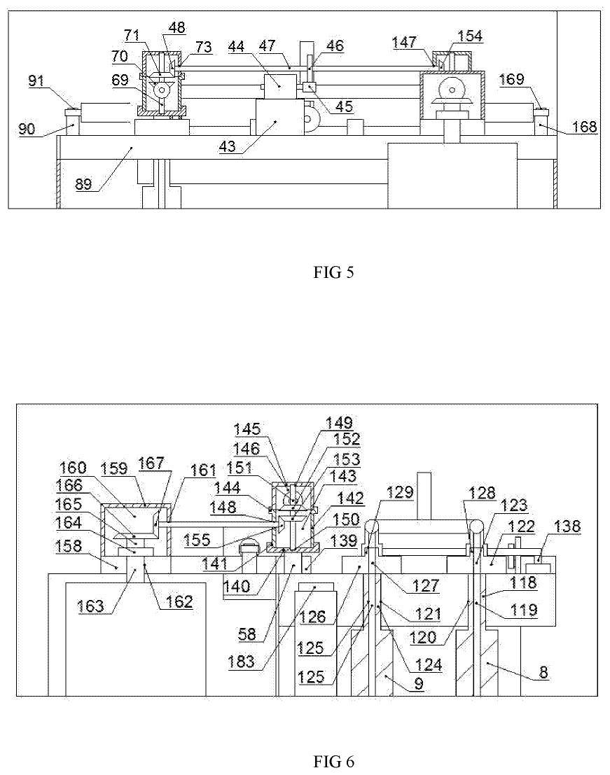

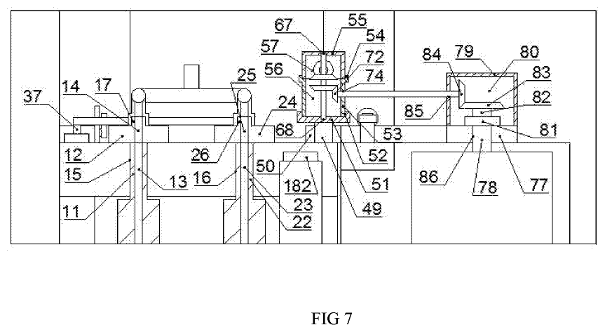

The present invention is described in detail below with reference to FIGS. 1-7. For convenience of description, the orientation described below is defined as follows: the up-down, left-right, front-back direction described below is consistent with the up-down, left-right, front-back direction of the projection relationship of FIG. 1-7, a traffic road fence cleaning device according to an embodiment of the present invention includes a U-shaped main body support frame, the U-shaped main body support frame includes a first main body beam 1, a first main body beam 2, and a first The two main body beams 3 are formed. The first main body beams 1 are extended left and right. The first main body beams 2 are fixed at the rear end of the first main body beams 1 near the left side. The beam 2 extends backward, the second main body beam 3 is fixed at a rear end of the first main body beam 1 near the right side, the second main body beam 3 extends rearward, and the first A third main body beam 4 extending rearward is fixed in the middle of the rear end of the main body beam 1, and a second main body beam 5 extending left and right is fixed at the rear end of the third main body beam 4. The left extension is fixedly connected to the rear end of the first main body side member 2, and the second main body cross beam 5 is fixedly connected to the rear end of the second main body side member 3.

A first cleaning column 6 and a second cleaning column 7 are provided on the lower side of the first main body beam 2. The first cleaning column 6 is located on the rear side of the second cleaning column 7. The first cleaning column 6 There are two symmetrically provided about the U-shaped main body support frame, the second cleaning column 7 is symmetrically provided about the U-shaped main body support frame, and a first power system is provided on the upper side of the U-shaped main body support frame. A second power system is provided on the upper side of the third main body longitudinal beam 4, a drum cleaning system is provided on the front side of the U-shaped main body support frame, and a water supply system is provided above the third main body longitudinal beam 4.

In addition, in one embodiment, the first cleaning column 6 is provided with a first water inlet hole 10 having an upward opening therein, and a first rotating mating body 11 extending upward is fixed at the top of the first cleaning column 6. The first main body longitudinal beam 2 is provided with a first cleaning post rotation fitting hole 15 and a second cleaning post rotation fitting hole 16 penetrating vertically. The first cleaning post rotation fitting hole 15 is located in the second cleaning post rotation. On the rear side of the fitting hole 16, the first rotation mating body 11 is rotationally fitted in the first washing column rotation mating hole 15, and the first rotation mating body 11 is provided with a second water inlet through hole which penetrates up and down. 13. A first rotation support block 12 is fixed at the top of the first rotation mating body 11, and a third water inlet through hole 14 is provided in the first rotation support block 12, and the first water inlet is The hole 10, the second water inlet through hole 13 and the third water inlet through hole 14 are communicated with each other. The second cleaning column 7 is provided with a fourth water inlet through hole 21 with an upward opening. A second rotating mating body 22 extending upward is fixed at the top of the two cleaning columns 7, and the second rotating mating The combined body 22 is rotatably fitted in the rotation cleaning hole 16 of the second cleaning column, and a fifth water inlet hole 23 penetrating up and down is provided in the second rotation fitting body 22, and the top of the second rotation fitting body 22 is fixed. There is a second rotating support block 24, and the second rotating support block 24 is provided with a sixth water inlet hole 25 penetrating up and down, the fourth water inlet hole 21, the fifth water inlet hole 23 and The sixth water inlet through hole 25 is communicated, a first water inlet 17 is fixed at the top of the first rotating support block 12, and a second water inlet 26 is fixed at the top of the second rotating support block 24. A first rotary projection 20 is fixed on a side of the top of the first rotation support block 12 near the third main body beam 4, and a top of the second rotation support block 24 is close to the third main body beam 4. A second rotating protrusion 27 is fixed on one side, and a first rocker 28 extending forward and backward is provided on the upper side of the first and second rotating support blocks 12 and 24. A first rotary projection mating hole 29 and a second rotary projection mating hole 30 are provided therethrough. The first rotary projection 20 is rotationally fitted in the first rotary projection 20. In the rotation projection fitting hole 29, the second rotation projection 27 is rotatably fitted in the second rotation projection fitting hole 30, and the first cleaning column 6 and the second cleaning column 7 are close to the first A first cleaning nozzle 18 is fixed on one side of the three-body stringer 4. The first cleaning nozzle 18 has five arrays in the up-down direction of the first cleaning column 6. The first cleaning nozzles 18 are in the first direction. Five cleaning columns 7 are also arrayed in the up-down direction. The first cleaning nozzle 18 on the first cleaning column 6 is provided with first and second water spray holes 19 penetrating from left to right. The first water spray hole 19 is in communication with the first water inlet through hole 10, and the first water spray hole 19 in the second cleaning column 7 is in communication with the fourth water inlet through hole 21.

In addition, in one embodiment, the second power system includes a motor 31. A first rotating block 32 is fixed on an output shaft of the motor 31, and a first rotating block 32 is fixed on a rear end edge of the first rotating block 32. Rotating the sliding protrusion 33, the first main body beam 5 is provided with a first sliding restraint protrusion 38 and a second sliding restraining protrusion 39 symmetrically at the top and left, and the first sliding restraint protrusion 38 is provided with left and right penetrations therein. A first sliding constraint hole 40, a second sliding constraint hole 41 penetrating left and right inside the second sliding constraint protrusion 39, and the first sliding constraint hole 40 and the second sliding constraint hole 41 slide left and right A first sliding rod 42 is provided in cooperation with a rotary sliding projection mating body 34 fixed in the middle of the front end of the first sliding rod 42, and a rotating sliding projection extending up and down extends at the front end of the rotary sliding projection mating body 34. A block fitting groove 35, a first sliding fitting groove 36 is provided at the top end of the first sliding lever 42 near the left side, the first sliding fitting groove 36 is arranged along the front left and rear right, and the first rocker 28 The rear end is fixed with a downwardly extending first rocker bump 37, and the first rocker bump 37 The sliding fit is in the first sliding fit groove 36.

In addition, in one embodiment, the first power system includes a main motor 44, a main motor support body 43 is fixed at the top of the first main body beam 1, and the main motor 44 is fixedly connected to the top of the main motor support. At the top of the body 43, a first gear 45 is fixed on the output shaft of the main motor 44. A second gear 46 is meshed with the upper side of the first gear 45. The second gear 46 is provided with a first gear extending left and right. A transmission shaft 47 is provided with a first bevel gear 48 fixed at the left end of the first transmission shaft 47, and a first rotating support body 49 and a second rotating support body 58 are symmetrically provided on the left and right sides of the top end of the first main body beam 1. A first rotation support ring 50 is provided on the outer ring of the first rotation support body 49. A first power box support base 51 is fixed on the top end of the first rotation support body 49. The first power box support base 51 is provided therein. A first supporting rotation mating cavity 52 having an upward opening, and a first power box lower casing 53 extending upward is provided in the first supporting rotation mating cavity 52 for rotation, and the first power box lower casing 53 is provided therein. A first power box lower receiving cavity 56 penetrating vertically, the first power A first power box rotation restricting ring 54 is provided on the outer ring of the lower case 53 near the top, and the first power box rotation restricting ring 54 is extended upward. A first side of the first power box lower case 53 is provided with a first A power box upper case 55 is rotatably fitted in the first power box rotation restraint ring 54, and the first power box upper case 55 is provided with an opening downward. A first power box receiving cavity 57, and a side of the first power box upper housing 55 near the main motor 44 is provided with a first power shaft fitting hole extending through the first power box receiving cavity 57. 73. A side of the first power box lower case 53 remote from the second main body beam 5 is provided with a second power shaft fitting hole 74 extending through the first power box lower receiving cavity 56. The top wall of the receiving cavity 57 on a power box is provided with a first gear shaft fitting hole 67 with an opening downward, and the bottom of the first supporting rotation matching cavity 52 is provided with a second gear shaft fitting hole 68 with an upward opening. A first gear shaft 69 extending up and down is provided between the gear shaft fitting hole 67 and the second gear shaft fitting hole 68 The lower end of the first gear shaft 69 is rotatably fitted in the second gear shaft fitting hole 68, and the upper end of the first gear shaft 69 is rotatably fitted in the first gear shaft fitting hole 67, the first gear shaft A second bevel gear 71 and a third bevel gear 70 are fixed on 69. The second bevel gear 71 is located on the upper side of the third bevel gear 70. The second bevel gear 71 and the first bevel gear 48 The third bevel gear 70 is meshed with a fourth bevel gear 72. A second drive shaft 75 is rotationally fitted in the second power shaft fitting hole 74, and the second drive shaft 75 extends forward and backward. In addition, in one embodiment, the drum cleaning system includes a first washing drum 87 and a second washing drum 88. A side of the first rotating support ring 50 away from the second main body beam 5 is fixed with a forward extension. A first cleaning roller support rod 76, a first cleaning roller support body 77 is fixed at the front end of the first cleaning roller support rod 76, and a first transmission box 79 is fixed at the upper end of the first cleaning roller support body 77; The first transmission case 79 is provided with a first transmission case accommodating cavity 80 having a downward opening, and a side of the first transmission case accommodating cavity 80 near the first power case lower case 53 is provided to the first transmission case. The gearbox receiving cavity 80 extends through a third gear shaft fitting hole 85, and the first washing drum support body 77 is provided with a first washing drum rotation fitting hole 86 penetrating up and down, and the first washing drum rotation fitting hole 86 A first cleaning drum connecting shaft 78 extending up and down is fitted in the inner rotation, the first cleaning drum 87 is fixedly connected to the lower end of the first cleaning drum connecting shaft 78, and a top end of the first cleaning drum connecting shaft 78 is fixed. A first cleaning roller supporting block 81, A first bevel gear connection shaft 82 is fixed on the top end of a cleaning drum support block 81, and a fifth bevel gear 83 is fixed on the top end of the first bevel gear connection shaft 82. The front part of the second transmission shaft 75 is rotatably fitted on the front part. In the third gear shaft fitting hole 85, a sixth bevel gear 84 is fixed at the front end of the second transmission shaft 75, and the sixth bevel gear 84 is meshed with the fifth bevel gear 83.

In addition, in an embodiment, the front end of the first main body beam 1 is fixed with an auxiliary beam 89 extending left and right, and a first fixing block 90 is provided at an upper end of the auxiliary beam 89 near the left side. A block 90 is located on the left side of the first cleaning roller support rod 76, a first rotation support short shaft 91 is fixed at the top of the first fixing block 90, and a first rotation is provided on the outer ring of the first rotation support short shaft 91 A supporting short-axis mating ring 92 is supported, and a first spring cylinder 94 is fixed on a side of the first rotating supporting short-axis mating ring 92 near the first cleaning drum support rod 76, and the first spring cylinder 94 A first spring cavity 95 with an opening to the right is provided, and a first spring pusher 97 is slidably fitted in the first spring cavity 95. A left end of the first spring pusher 97 and a left side of the first spring cavity 95 are provided. A first spring 96 is press-fitted between the walls. A second rotation support stub 98 is fixed on the top of the first cleaning drum support rod 76, and a second rotation is provided on the outer ring of the second rotation support stub 98. Support the short shaft mating ring 99, the right end of the first spring pusher 97 and the second rotating support short shaft The mating ring 99 is fixedly connected.

In addition, in an embodiment, a first dust suction tube connection block 100 is fixed at the left end of the first main body beam 1, and a left first section extending downward is fixed at the left end of the first suction tube connection block 100. A dust suction pipe 101, a left suction pipe interface 182 is fixed at the top of the left first stage suction pipe 101, and the first cleaning column 6 and the second cleaning column 7 are located close to the third main body longitudinal beam below One side of 4 is provided with a second left section of the suction pipe 103, which is extended forward and backward, and the left second section of the suction pipe 103 is provided with a leftward extension near the front end. The left third section of the suction tube 102, the right end of the left third section of the suction tube 102 is in communication with the front end of the left second section of the suction tube 103, and the left end of the left third section of the suction tube 102 is in communication with The lower end of the first left section of the vacuum cleaner pipe 101 is communicated, and the right side of the second left section of the vacuum cleaner pipe 103 is provided with a first suction tank 104 extending forward and backward.

In addition, in one embodiment, the water supply system includes a first section of the water supply pipe 105, the first section of the water supply pipe 105 is located above the third main body longitudinal beam 4, and the first section of the water supply pipe 105 extends forward and backward The rear end of the first section of water supply pipe 105 is connected to a second section of water supply pipe 106 extending left and right, and the left end of the second section of water supply pipe 106 is connected to the first water inlet 17 and the first section The front end of the segmented water supply pipe 105 is connected to a third segmented water supply pipe 107 extending left and right, and the left end of the third segmented water supply pipe 107 is connected to the second water inlet 26 and is disposed.

In addition, in one embodiment, the right end of the second main body beam 5 is fixed with a vehicle frame connecting rod 108 extending rightward, and the right end of the vehicle frame connecting rod 108 is fixed with a first vehicle frame vertical rod 110 extending up and down. The right end of the auxiliary cross beam 89 is fixed with a second vehicle frame vertical bar 109 extending up and down, and the first vehicle frame vertical bar 110 and the second vehicle frame vertical bar 109 are provided with a vehicle frame extending forward and backward. A longitudinal beam 111, the front and rear ends of the vehicle-mounted frame connecting the longitudinal beam 111 are fixedly connected to the rear side of the second vehicle-frame vertical bar 109 and the front side of the first vehicle-mounted vertical bar 110, respectively, and the second vehicle A first vehicle-mounted hook 112 and a second vehicle-mounted hook 113 are provided on the right side of the frame vertical rod 109, and the second vehicle-mounted hook 113 is located above the first vehicle-mounted hook 112. There is a third vehicle-mounted hook 114 and a fourth vehicle-mounted hook 115, and the fourth vehicle-mounted hook 115 is located above the third vehicle-mounted hook 114.

In the following, the applicant will specifically introduce a traffic road fence cleaning device of the present application with reference to FIGS. 1-7 and the above description:

A traffic road fence cleaning device in the present invention is hung on a traffic cleaning vehicle as a whole, and moves as the traffic cleaning vehicle advances. Both the left suction pipe interface 182 and the right suction pipe interface 183 are cleaned with traffic. The suction pipe on the car is connected. When a traffic road fence cleaning device is required to work, external water sources enter the first section of water supply pipe 105, and external water sources enter the second section of water supply pipe 105 and enter the second section respectively. An external water source enters the first water inlet port 17 through the second stage water supply pipe 106 and the third stage water supply pipe 107, and an external water source enters the first water inlet via the third stage water supply pipe 107. A second water inlet 26, an external water source enters the third water inlet through the first water inlet 17, and an external water source enters the second water inlet through the third water inlet 14 Inside 13, an external water source enters the first water inlet 10 through the second water inlet hole 13, and an external water source in the first water inlet 10 finally passes through the first water injection hole 19 ejection.

Start the motor 31, the motor 31 drives the first rotating block 32 to rotate, the first rotating block 32 drives the first rotating sliding protrusion 33 to rotate, and the first rotating sliding protrusion 33 Drives the rotary sliding projection mating body 34 to move left and right periodically, the rotary sliding projection mating body 34 drives the first sliding bar 42 to move left and right periodically, and the first sliding bar 42 drives the first sliding The mating groove 36 moves periodically from side to side. The first sliding mating groove 36 drives the first rocker bump 37 to move forward and backward periodically. The first rocker bump 37 drives the first rocker 28 to move forward and backward periodically. The first rocker rod 28 drives the first rotating projection fitting hole 29 and the second rotating projection fitting hole 30 to move forward and backward periodically. The first rotating projection fitting hole 29 drives the first rotating protrusion. The block 20 rotates back and forth around the first washing column rotation fitting hole 15, the first rotating projection 20 drives the first rotating support block 12 to rotate back and forth, and the first rotating support block 12 drives the first A rotating mating body 11 rotates back and forth periodically. The body 11 drives the first cleaning upright 6 to rotate periodically back and forth, the first cleaning upright 6 drives the first cleaning nozzle 18 to rotate back and forth periodically, and the second rotating projection mating hole 30 drives the second rotating projection The block 27 rotates back and forth around the second cleaning post rotation fitting hole 16. The second rotating projection 27 drives the second rotating support block 24 to rotate back and forth periodically. The second rotating support block 24 drives the first The two rotating mating bodies 22 rotate periodically back and forth, and the second rotating mating body 22 drives the second cleaning column 7 to rotate periodically back and forth.

The main motor 44 is started, the main motor 44 drives the first gear 45 to rotate, the first gear 45 drives the second gear 46 to rotate, and the second gear 46 drives the first transmission shaft 47 Rotating, the first transmission shaft 47 drives the first bevel gear 48 to rotate, the first bevel gear 48 drives the second bevel gear 71 to rotate, and the second bevel gear 71 drives the first gear shaft 69 rotates, the first gear shaft 69 drives the third bevel gear 70 to rotate, and the third bevel gear 70 drives the fourth bevel gear 72 to rotate. The fourth bevel gear 72 drives the second transmission shaft 75 to rotate, the second transmission shaft 75 drives the sixth bevel gear 84 to rotate, and the sixth bevel gear 84 drives the fifth bevel gear 83 to rotate The fifth bevel gear 83 drives the first bevel gear connection shaft 82 to rotate, the first bevel gear connection shaft 82 drives the first cleaning drum support block 81 to rotate, and the first cleaning drum support block 81 The first cleaning drum connection shaft 78 is driven to rotate, and the first cleaning drum connection shaft 78 is driven to rotate the first cleaning drum 87.

When a traffic road fence cleaning device works, a traffic fence is passed from the back to the middle of the lower side of the U-shaped main body support frame, and the traffic fence is connected to the first cleaning drum 87 and the second cleaning drum 88. In the middle, the high-pressure water jets sprayed from several cleaning nozzles on the first cleaning column 6 and the second cleaning column 7 scour and clean the traffic fence. The first suction tank 104 sucks in excess water mist. Recovered, the first cleaning roller 87 and the second cleaning roller 88 will perform deep-wiping cleaning on the traffic fence again.

The beneficial effects of the present invention are: the structure of the present invention is simple, and the operation is convenient. The high-pressure water flow sprayed from several cleaning nozzles on the four groups of cleaning columns, the high-pressure water flow scours the traffic fence and causes the dirt on the surface to fall off. The dust pipe collects and processes part of the water mist and dust to prevent secondary pollution. The cleaning roller is responsible for the final wiping and secondary cleaning functions, to ensure the cleaning quality of the traffic fence, and to efficiently and quickly clean the traffic fence.

The above are only preferred embodiments of the present invention, and are not intended to limit the present invention. Any modification, equivalent replacement, or improvement made within the spirit and principle of the present invention shall be included in the present invention. Within the scope of protection.

1. A traffic road fence cleaning apparatus, comprising a U-shaped main body support frame, the U-shaped main body support frame is composed of a first main body beam, a first main body beam, and a second main body beam, and the first main body beam is left and right Extended, the first main body beam is fixed at a rear end of the first main body beam near a left side, the first main body beam is extended rearward, and the second main body beam is fixed at the rear end of the first main body beam is close to the right side, the second main body beam is extended rearwardly, and the third main body beam extended rearwardly is fixed in the middle of the rear end of the first main body beam. A second main body beam extending left and right is fixed at the rear end of the three main body beams. The second main body beam extends to the left and is fixedly connected to the rear end of the first main body beam. The second main body beam extends right to the rear end of the second main body longitudinal beam is fixedly connected; a first cleaning post and a second cleaning post are provided on the lower side of the first main body longitudinal beam, and the first cleaning post is located on the rear side of the second cleaning post. Said first cleaning column about said U-shaped main Two support frames are provided symmetrically, and the second cleaning column is provided symmetrically with respect to the U-shaped main body support frame. A first power system is provided on the upper side of the U-shaped main body support frame. A second power system is provided on the upper side of the beam, a drum cleaning system is provided on the front side of the U-shaped main body support frame, and a water supply system is provided above the third main body longitudinal beam.

2. The cleaning device for a traffic road fence according to claim 1, characterized in that: the first cleaning column is provided with a first water inlet through hole which opens upward, and the top of the first cleaning column is fixedly provided. A first rotation mating body extending upward, the first main body longitudinal beam is provided with a first cleaning column rotation mating hole and a second cleaning column rotation mating hole penetrating up and down, and the first cleaning column rotation mating hole is located in the The rear side of the second cleaning post rotation fitting hole, the first rotation fitting body is rotationally fitted in the first cleaning post rotation fitting hole, and the first rotation fitting body is provided with a second water inlet through hole which penetrates up and down. A first rotation support block is fixed on the top of the first rotation coordination body, and a third water inlet through hole is provided in the first rotation support block; A second water inlet hole is provided in communication with the third water inlet hole, a fourth water inlet hole with an upward opening is provided in the second cleaning column, and an upwardly extending fixing hole is fixed at the top of the second cleaning column. Second rotation mating body, said first A rotation mating body is rotationally mated in the rotation mating hole of the second cleaning column, a fifth water inlet through hole is provided in the second rotation mating body, and a second rotation is fixed at the top of the second rotation mating body. A support block, the sixth rotating support block is provided with a sixth water inlet hole penetrating vertically, and the fourth water inlet hole, the fifth water inlet hole and the sixth water inlet hole are connected; A first water inlet is fixed at the top of the first rotation support block, a second water inlet is fixed at the top of the second rotation support block, and the top of the first rotation support block is close to the third body A first rotary projection is fixed on one side of the longitudinal beam, and a second rotary projection is fixed on the side of the top of the second rotary support block near the third main body longitudinal beam. The first rotary support block and A first rocker extending forward and backward is provided on the upper side of the second rotation support block, and a first rotary projection fitting hole and a second rotary projection fitting hole penetrating up and down are provided in the first rocker. A rotating protrusion is rotationally fitted in the first rotating protrusion fitting hole, and the second A rotating projection is rotationally fitted in the second rotating projection fitting hole, and a first cleaning nozzle is fixed on a side of the first cleaning column and the second cleaning column near the third main body longitudinal beam. There are five first cleaning nozzles arrayed in the up and down direction of the first cleaning column, and five first cleaning nozzles are also arrayed in the up and down direction of the second cleaning column. The first cleaning nozzle is provided with a first water spray hole penetrating from left to right, the first water spray hole on the first cleaning column is communicated with the first water inlet through hole, and the second cleaning column is The first water spray hole is in communication with the fourth water inlet hole.

3. The cleaning device for a traffic road fence according to claim 1, wherein the second power system comprises a motor, and a first rotation block is fixed on an output shaft of the motor, and the first rotation block A first rotary sliding projection is fixed at the rear end edge, and a first sliding constraint projection and a second sliding constraint projection are fixed symmetrically at the top and bottom of the second main body beam. A first sliding restraint hole penetrating from left to right is provided, and a second sliding restraint hole penetrating from left to right is provided in the second sliding restraint projection, and the first sliding restraint hole and the second sliding restraint hole are slidably matched to each other. A first sliding rod is provided, and a rotary sliding projection mating body is fixedly fixed in the middle of the front end of the first sliding rod. The front end of the rotary sliding projection mating body is provided with a rotating sliding projection mating groove extending up and down. A first sliding engagement groove is provided at the top of the first sliding rod near the left side, the first sliding engaging groove is disposed along the front left and rear right, and the rear end of the first rocker is fixed with a first extending downward groove. A rocker bump, the first rocker Block sliding fit in the first sliding slot fit.

4. The traffic road fence cleaning device according to claim 1, wherein the first power system includes a main motor, and a main motor support body is fixed at the top of the first main body beam, and the main motor A first gear is fixedly connected to the top of the main motor support body at the top, a first gear is fixed on the output shaft of the main motor, a second gear is meshed and connected on the upper side of the first gear, and the left and right sides of the second gear are extended inside. A first transmission shaft is provided, and a first bevel gear is fixed on the left end of the first transmission shaft. A first rotating support body and a second rotating support body are symmetrically arranged on the left and right sides of the top end of the first main body beam. A first rotation support ring is provided on the outer ring of the rotation support body, a first power box support base is fixed on the top of the first rotation support body, and a first support rotation fit is provided in the first power box support base. A first power box lower housing extending upwardly in the first support rotation matching cavity, and a first power box lower receiving cavity penetrating up and down in the first power box lower housing, First move A first power box rotation restraint ring is provided on a position ring near the top of the outer side of the lower case of the box, the first power box rotation restraint ring is extended upward, and a first power box is provided on the upper side of the first power box lower case An upper case, the first power case upper case is rotationally fitted in the first power case rotation restraint ring, and the first power case upper case is provided with a first power case upper receiving cavity having an opening downward, A side of the upper case of the first power box near the main motor is provided with a first power shaft fitting hole extending through the upper cavity of the first power box, and the lower case of the first power box is far from A side of the second main body beam is provided with a second power shaft fitting hole extending through the lower cavity of the first power box, and a first gear on the top wall of the first power box is provided with a first gear facing downward. A shaft fitting hole, a second gear shaft fitting hole with an upward opening is provided at the bottom of the first support rotation fitting cavity, and a first and a third extension shaft are provided between the first gear shaft fitting hole and the second gear shaft fitting hole A gear shaft, the lower end of the first gear shaft is rotationally matched In the second gear shaft fitting hole, the upper end of the first gear shaft is rotationally fitted in the first gear shaft fitting hole, and a second bevel gear and a third bevel gear are fixed on the first gear shaft. The second bevel gear is located on the upper side of the third bevel gear. The second bevel gear is meshed with the first bevel gear. The third bevel gear is meshed with a fourth bevel gear. A second transmission shaft is rotationally fitted in the two power shaft matching holes, and the second transmission shaft is extended forward and backward.

5. The cleaning device for a traffic road fence according to claim 1, characterized in that the drum cleaning system comprises a first cleaning drum and a second cleaning drum, and the first rotating support ring is far from the second main beam. A first cleaning drum support rod extending forward is fixed on one side, a first cleaning roller support is fixed on the front end of the first cleaning roller support rod, and a first transmission is fixed on the upper end of the first cleaning roller support. Box, the first transmission box is provided with a first transmission box accommodating cavity having an opening downward, and a side of the first transmission box accommodating cavity near the lower case of the first power box is provided to the first transmission box. A third gear shaft mating hole extending through the gearbox accommodating cavity, the first washing drum supporting body is provided with a first washing drum rotation fitting hole penetrating up and down, and the first washing drum rotation fitting hole is provided with up and down fitting An extended first cleaning drum connecting shaft, the first cleaning drum is fixedly connected to a lower end of the first cleaning drum connecting shaft, and a first cleaning drum supporting block is fixed at the top end of the first cleaning drum connecting shaft. A first bevel gear connection shaft is fixed at the top of the first cleaning drum support block, a fifth bevel gear is fixed at the top of the first bevel gear connection shaft, and the front part of the second transmission shaft is rotationally fitted to the first bevel gear. A sixth bevel gear is fixed at the front end of the second transmission shaft in the three gear shaft fitting hole, and the sixth bevel gear is meshed with the fifth bevel gear.

6. The cleaning device for a traffic road fence according to claim 1, characterized in that: the front end of the first main body beam is fixed with auxiliary beams extending left and right, and the upper end of the auxiliary beam is provided with a first A fixing block, the first fixing block is located on the left side of the support rod of the first cleaning drum, a first rotary support short shaft is fixed at the top end of the first fixing block, and the outer side of the first rotary support short shaft is annularly arranged There is a first rotating support short-axis matching ring, and a first spring cylinder is fixed on a side of the first rotating support short-axis matching ring near the first cleaning drum support rod. There is a first spring cavity with an opening to the right, and a first spring push rod is slidably fitted in the first spring cavity. The left end of the first spring push rod and the left side wall of the first spring cavity are press-fitted. A first spring is provided, and a second rotation support short shaft is fixed on the top of the first cleaning drum support rod. A second rotation support short shaft mating ring is provided on the outer ring of the second rotation support short shaft. The right end of the spring push rod and the second rotary support Ring is fixedly connected with the shaft.

7. The cleaning device for a traffic road fence according to claim 1, wherein a left end of the first main body beam is fixed with a first suction pipe connection block, and a left end of the first suction pipe connection block is fixed. A left first section of suction pipe extending downward is provided, and a left suction pipe interface is fixed at the top of the left first section of suction pipe, and the first cleaning column and the second cleaning column are located close to the bottom of the second cleaning column. The third main body longitudinal beam is provided with a second left section of the suction pipe on one side, the second left section of the suction pipe is extended forward and backward, and the left second section of the suction pipe is provided with a leftward position near the front end. The extended left third section of the suction pipe, the right end of the third left section of the suction pipe is in communication with the front end of the left second section of the suction pipe, and the left end of the left third section of the suction pipe is connected to the left The lower end of the first section of the suction pipe is communicated, and the right side of the left and second section of the suction pipe is provided with a first suction groove extending forward and backward.

8. The cleaning device for a traffic road fence according to claim 1, wherein the water supply system comprises a first section of water supply pipe, and the first section of water supply pipe is located above the third main body longitudinal beam, so that The first section of the water supply pipe is extended forward and backward, the rear end of the first section of the water supply pipe is connected to the second section of the water supply pipe extended left and right, and the left end of the second section of the water supply pipe is connected to the first water inlet. The front end of the first section of the water supply pipe is connected to a third section of the water supply pipe extending left and right, and the left end of the third section of the water supply pipe is connected to the second water inlet.

9. The cleaning device for a traffic road fence according to claim 1, characterized in that the right end of the second main body beam is fixed with a vehicle-mounted frame connecting rod extending to the right, and the right end of the vehicle-mounted frame connecting rod is fixed with a vertical extension A first vehicle-mounted frame vertical rod, a second vehicle-mounted frame vertical rod extending up and down is fixed at the right end of the auxiliary cross beam, and a front-to-rear extension is provided between the first vehicle-mounted frame vertical rod and the second vehicle-mounted frame vertical rod. The vehicle-mounted frame is connected to a longitudinal beam, and the front and rear ends of the vehicle-mounted frame are connected to the rear side of the second vehicle-frame vertical rod and the front side of the first vehicle-mounted vertical rod, respectively. A first vehicle hook and a second vehicle hook are provided on the right side of the vertical rod, the second vehicle hook is located above the first vehicle hook, and a third vehicle hook and a first vehicle hook are provided on the right side of the first vehicle frame vertical rod. Four vehicle-mounted hooks, the fourth vehicle-mounted hook is located above the third vehicle-mounted hook.
